(19) United States
(12) Patent Application Publication
(10) Pub. No.: US 2026/0124928 A1
(43) Pub. Date: May 7, 2026

(54) VEHICLE AND ACCESSORY COMMUNICATION AND CONTROL

(71) Applicant: Rivian IP Holdings, LLC, Irvine, CA (US)

(72) Inventors: Paula Michelle Lobaccaro, San Clemente, CA (US); Kaitlyn Noel Pinckert, Irvine, CA (US); Erik Robert Glaser, San Mateo, CA (US); Austin Lee Frederickson, Carlsbad, CA (US); Daniel Geoffrey Walker, Dana Point, CA (US); Peter Mulqueen, Irvine, CA (US); Evan Patrick Higgins, Mission Viejo, CA (US)

(21) Appl. No.: 19/363,311

(22) Filed: Oct. 20, 2025

Related U.S. Application Data
(60) Provisional application No. 63/717,670, filed on Nov. 7, 2024.

(51) Int. Cl. B60L 15/20; B60R 16/023; B60R 16/03; H04L 67/12

(52) U.S. Cl. CPC B60L 15/20; B60R 16/023; B60R 16/03; H04L 67/12

(57) ABSTRACT

Systems and methods for integrating accessories with a vehicle, and more particularly to systems and methods for controlling interaction between a vehicle and an accessory. The systems and methods include detecting a presence of an accessory coupled to an exterior of a vehicle and determining, using control circuitry, an accessory type of the detected accessory (e.g., a tent, lighted crossbar, camp kitchen). The systems and methods further include adjusting, using the control circuitry, a vehicle parameter based on the accessory type (e.g., adjust suspension firmness or height).

### CROSS-REFERENCE TO RELATED APPLICATIONS

This application claims the benefit of U.S. Provisional Application No. 63/717,670, filed Nov. 7, 2024, the disclosure of which is hereby incorporated by reference herein in its entirety.

### INTRODUCTION

The present disclosure is directed to systems and methods for integrating accessories with a vehicle, and more particularly to systems and methods for controlling interaction between a vehicle and an accessory.

### SUMMARY

A vehicle's exterior may be outfitted with any of a variety of different accessories. However, incorporating accessories may affect performance of the vehicle. In some situations, an accessory may change any of the vehicle's weight, center of gravity, or coefficient of drag, which may negatively impact handling, range, or stopping distance. The vehicle may not know what accessory is connected and thus may not be able to adjust to accommodate the accessory. Further, some accessories utilize or require power and a data connection to control aspects of the accessory. Incorporating these accessories may require modifications to the vehicle's exterior or to an electrical system of the vehicle.

To solve these problems, systems and methods are provided herein for improving integration of accessories with vehicles.

In some embodiments, methods and systems are provided for modifying a vehicle parameter based on an accessory (e.g., an accessory type). A presence of an accessory coupled to an exterior of a vehicle is detected and the type of accessory is determined. A vehicle parameter is adjusted based on the type of accessory. In some embodiments, adjusting the vehicle parameter includes modifying at least one of a predicted vehicle range, vehicle exterior profile, vehicle suspension (e.g., suspension firmness or height), steering threshold or limit, a steering ratio, braking threshold or limit, or acceleration threshold or limit, a maximum vehicle speed, traction control, or vehicle user interface.

In some embodiments, determining the accessory is coupled to the exterior of the vehicle is based on determining a vehicle parameter is outside of an expected performance range. In some embodiments, the expected performance range is one of a vehicle range, distance to surroundings, vehicle weight, engine output, brake input, or vehicle speed or acceleration.

In some embodiments, a sensor is used to detect the presence of the accessory and the sensor comprises any of a proximity sensor, a camera, a load sensor, or an accelerometer.

In some embodiments, the methods and systems further determine whether the detected accessory utilizes power, and in response to determining that the detected accessory utilized power, provide power to the accessory.

In some embodiments, the methods and systems further determine whether the detected accessory comprises controllable elements, and in response to determining that the detected accessory comprises one or more controllable elements, generate for display a user interface to control the one or more controllable elements. In some embodiments, the detected accessory is a camper shell or tent, and the one or more controllable elements comprises an interior temperature, an electrical outlet, or a light, or a combination thereof.

In some embodiments, the methods and systems further determine a classification of the accessory, wherein adjusting the vehicle parameter is based on the classification.

In some embodiments, the methods and systems adjust the vehicle parameter by generating for display a user interface comprising instructions placing one or more leveling blocks under one or more wheels to level the vehicle.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic illustration of a vehicle accessory system, in accordance with embodiments of the disclosure;

FIGS. 2A-2C are schematic illustrations of vehicle accessory systems having different types of accessories coupled to a roof of a vehicle, in accordance with embodiments of the disclosure;

FIG. 3A is a flowchart of an illustrative process for controlling interaction between a vehicle and an accessory, in accordance with embodiments of the disclosure;

FIG. 3B is a flowchart of an illustrative process for controlling interaction between a vehicle and an accessory based on a classification of the accessory, in accordance with embodiments of the disclosure;

FIG. 4 is a representation of a graphical user interface of a vehicle accessory system, in accordance with embodiments of the disclosure;

FIGS. 5A-5C are schematic illustrations of a vehicle leveling system, in accordance with embodiments of the disclosure;

FIGS. 6A and 6B are schematic illustrations of different stacking configurations for leveling blocks of a vehicle leveling system, in accordance with embodiments of the disclosure;

FIGS. 7A-7C are representations of different graphical user interfaces of a vehicle leveling system, in accordance with embodiments of the disclosure;

FIGS. 8A-8C are schematic illustrations of different leveling block configurations, in accordance with embodiments of the disclosure; and

FIG. 9 is a flowchart of an illustrative process for leveling a vehicle using a vehicle leveling system, in accordance with embodiments of the disclosure.

### DETAILED DESCRIPTION

A vehicle may include an accessory coupled to an exterior of the vehicle. In some situations, the accessory may be attached to different locations on the exterior of the vehicle, such as, for example, a roof, cross bar on the roof, front or grill, hood, side panel, hood, rear or tail gate or lift gate, or an attachment point such as a tow hook. Different types of accessories can be attached to the vehicle. In some situations, the accessory has a controllable operation or subsystem that the vehicle is able to control. In some situations, the presence of the accessory affects the performance or other aspects of the vehicle.

In some embodiments, the present disclosure is directed to methods and systems for providing power and/or controlling aspects of an accessory coupled to a vehicle. Although a sport utility vehicle (SUV) is shown, the vehicle can include any type of vehicle to which accessories are mounted, including but not limited to a truck, car, hatchback, minivan, all-terrain vehicle (ARV), side by side (S×S), golf cart, airplane, or helicopter. In some embodiments, a vehicle parameter is modified to account for how the accessory affects performance or operation of the vehicle. In some embodiments, the present disclosure is directed to methods and systems for enabling features of an accessory device and/or a vehicle based on a classification or tier of the accessory. In some embodiments, the present disclosure is directed to methods and systems for leveling a vehicle using leveling blocks. In some implementations, the vehicle is leveled for only a subset of accessory types (e.g., tent or kitchen accessories).

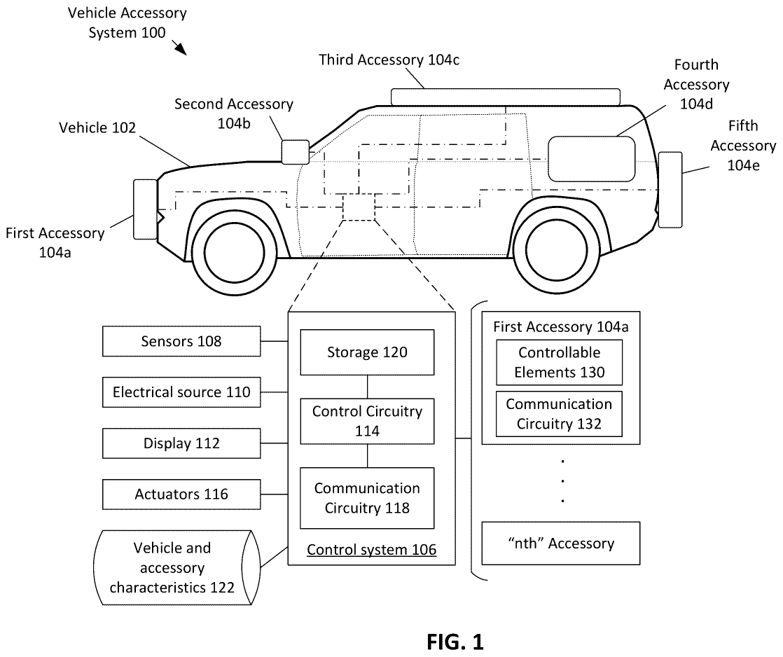

FIG. 1 is a schematic illustration of a vehicle accessory system 100, in accordance with embodiments of the disclosure. As shown, the system includes a vehicle 102, accessories (e.g., first through fifth accessories 104a-e), control system 106, and sensors 108. In some embodiments, the vehicle includes an electrical source 110 (e.g., battery, alternator, supercapacitor, flywheel etc.) to generate and/or store energy, and a display 112 (e.g., of an infotainment system). The system 100 may be used to seamlessly and intelligently integrate accessories with the vehicle 102. For example, the system 100 may be used in combination with the methods described below to communicate, control, and/or respond to accessories coupled to the vehicle.

In some embodiments, the accessories are mounted to different locations of the exterior of the vehicle. In the embodiment depicted in FIG. 1, the first accessory 104a through the fifth accessory 104e are mounted to a front, front driver's side, roof, rear driver's side, and rear of the vehicle, respectively. In some embodiments, the accessories are electrically coupled to ports (or outlets) of the vehicle. In some embodiments, the accessories are powered accessories and include at least one of a rooftop camper shell or tent, bike rack, powered locking mechanism, lighted crossbar or lightbar, powered crossbar, powered awning, heated shower, camp kitchen, or roof box or cargo container. In some implementations, the powered accessories include a subsystem to provide functionality of the accessory. For example, a camper shell may include a motor for opening and stowing the shell. A bike rack may include a powered lock to lock and secure bikes to the rack. A lighted crossbar may include lights that can be turned on and off. A powered crossbar may include a port for connecting accessories that can be turned on and off. Thus, an accessory may provide power and/or a data connection to other accessories. A powered awning may include a motor to extend and retract the awning. A heated shower may include a heating element to heat water. Each accessory may couple to a different attach point on the vehicle exterior.

In some embodiments, the control system 106 includes control circuitry 114 that is coupled to sensors 108, actuators 116 (e.g., motors), interfaces, and any other suitable components to control one or more accessory or accessory subsystem. In some embodiments, the control circuitry 114 monitors sensor signals, generates control signals, executes computer readable instructions, receives inputs, or a combination thereof. In some embodiments, the control circuitry 114 provides power and/or a data connection to the accessories. In some embodiments, an accessory (e.g., powered crossbar) may include a port to provide power to a downstream accessory. In some implementations, the accessory may pass-through the power and/or data connection from the control circuitry 114. In some examples, the control circuitry 114 controls the accessory and the downstream accessory. In some implementations, the accessory includes circuitry (e.g., control circuitry) that controls the downstream accessory. In some embodiments, the control circuitry 114 installs, removes, or modifies software or firmware of the accessory.

In some embodiments, the control system 106 includes communications circuitry 118 for communicating with other systems. In some implementations, the communications circuitry 118 includes any of an antenna, receiver, transceiver, transceiver circuitry, or other circuitry, or any combination thereof, and may be configured to access the internet, a local area network, wide area network, Bluetooth-enabled device, near field communication (NFC)-enabled device, Wi-Fi enabled device, cellular (e.g., 2G/3G/4G/5G) enabled device, or any other suitable device using any suitable protocol. In some implementations, the communications circuitry 118 is used to communicate with an accessory or another system (e.g., another vehicle, server, or user device (e.g., smartphone)). In some examples, the communications circuitry 118 wirelessly communicates with the accessory. In some examples, the communications circuitry 118 uses a wired connection (e.g., in a port) to communicate with the accessory. In some implementations, the control circuitry 114 receives an input from a user device that is not connected to a cellular network.

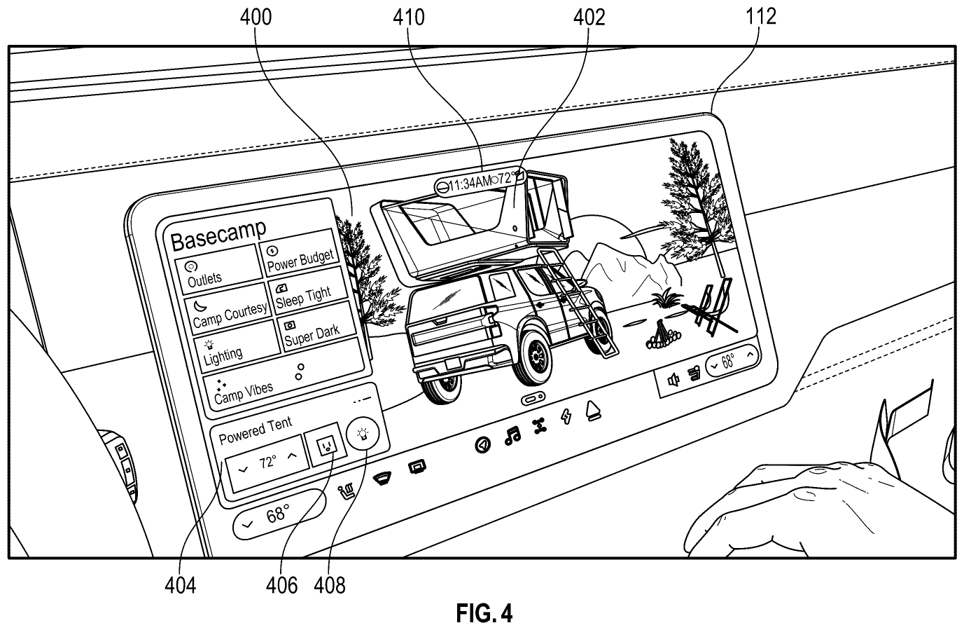

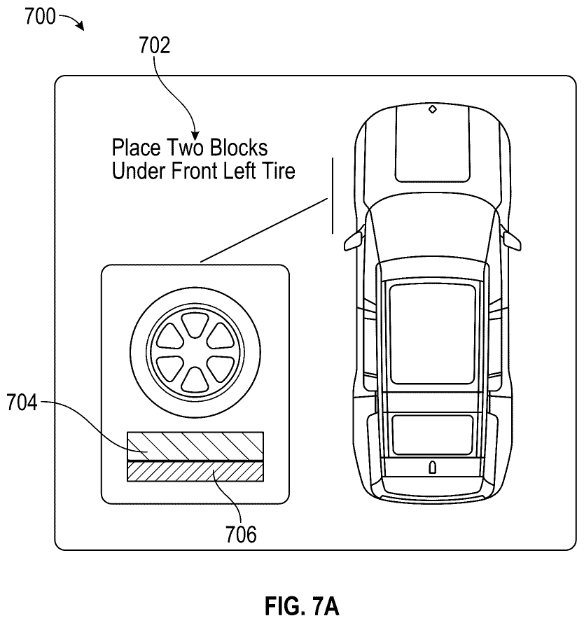

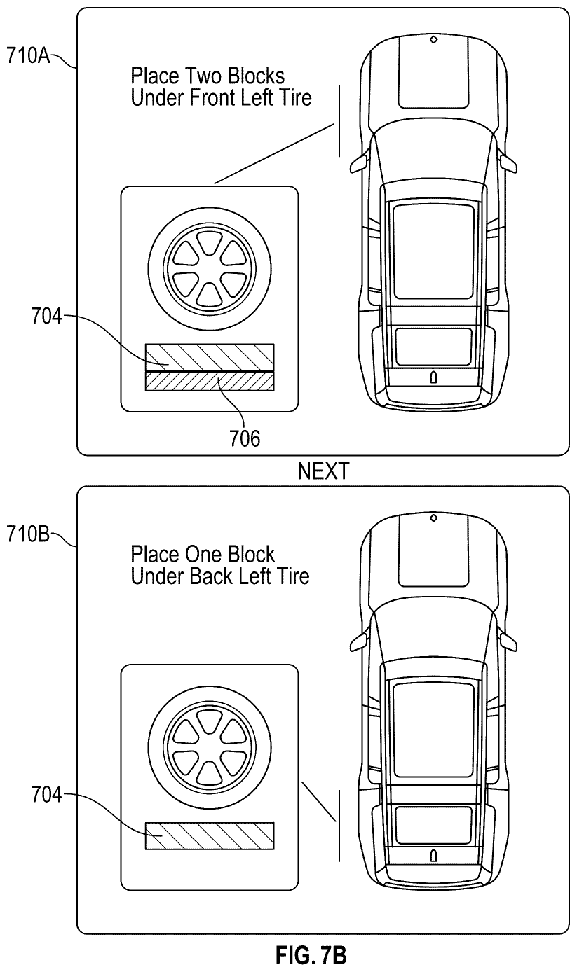

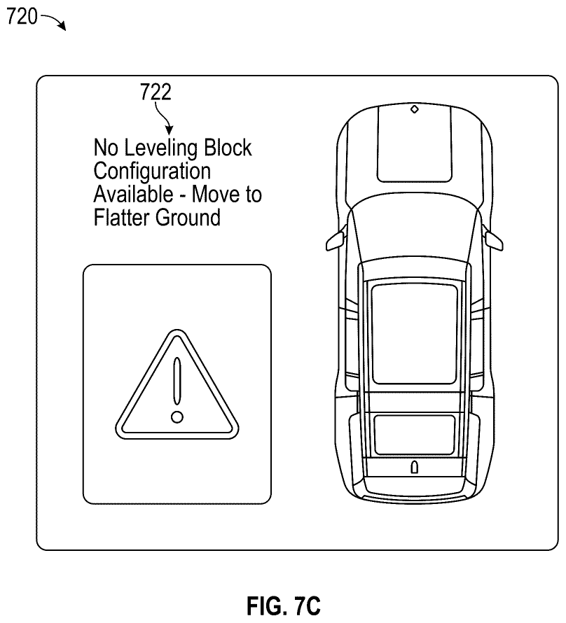

In some embodiments, the communication circuitry 118 includes input/output (I/O) circuitry (e.g., or I/O path) to receive inputs and/or send outputs. In some implementations, the I/O circuitry receives inputs from and/or sends outputs to at least one of an accessory, user interface (e.g., displayed on the display 112, such as discussed below, in relation to FIGS. 4 and 7A-7C), sensors, or communications circuitry. In some embodiments, the control circuitry 114 communicates with the user device through the I/O circuitry. In some embodiments, the vehicle 102 can communicate with the accessories (e.g., via the control circuitry 114) and can enable a control of the accessory for mobile application (e.g., via a smart phone or the display 112). In some embodiments, the vehicle 102 includes one or more electrical ports for electrically (and/or communicatively) coupling to a connector (e.g., or port) of an accessory. In some implementations, the control circuitry 114 provides power and/or control the accessories through the ports. In some implementations, the ports provide a quick connect system to be used to attach an accessory to the port. In some embodiments, the vehicle ports include a retention feature to retain the connector in the port and/or a disconnect feature to engage to remove the connector from the port. In some embodiments, the control circuitry 114 does not provide power to the vehicle port when an accessory connector is not connected. In some embodiments, the vehicle ports include short circuit protection (e.g., a fuse).

In some embodiments, the system 100 includes storage 120. In some embodiments, the storage 120 is an electronic storage device provided that is part of the control circuitry 114. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. The storage 120 may be used to store various types of content described herein as well as sensor data as described below. In some implementations, nonvolatile memory is also used (e.g., to launch a boot-up routine and other instructions). In some implementations, cloud-based storage or server-based storage is used to supplement storage 120 or instead of the storage 120.

In some implementations, the storage 120 includes non-transitory memory with non-transitory instructions, that when executed (e.g., by the control circuitry 114), cause the execution of applications to control aspects of the accessories and/or performance characteristics of the vehicle. In one example, the control circuitry 114 and communication circuitry 118 are part of a computer having the non-transitory memory. In some embodiments, the instructions are provided by the control circuitry through the communication circuitry 118 and/or communications circuitry.

In some embodiments, the vehicle accessory system 100 includes a power delivery system such as, for example, a system having controllable electrical contacts for providing power. In some embodiments, the electrical source 110 includes a battery system (e.g., also referred to as an energy storage system (ESS)) that may include a plurality of battery cells, enclosures, and power electronics (e.g., a DC-DC converter, switches, alternator). The electrical source 110 provides power to the accessories. The vehicle may include drive units that may include motors, gearing, bearings, hubs, shafts, gearbox housings, any other suitable components, or any combination thereof. For example, each drive unit may include an inverter, electric motor, and a gearbox for providing torque to a respective wheel or drive axis of the electric vehicle via a half-shaft and constant-velocity (CV) joint.

The vehicle 102 includes a propulsion system (e.g., a drive machine) to drive movement of the vehicle. In some embodiments, the propulsion system includes one or more electric motors to rotate wheels of the vehicle 102. In some embodiments, the electric motors are couped to a driveshaft that is coupled to the wheels. In some embodiments, the electric motors directly drive rotation of the wheels. In some embodiments, the propulsion system includes a combustion engine (e.g., using gas, diesel, or a fuel cell) to rotate wheels of the vehicle. In some embodiments, the propulsion system generates torque to rotate the wheels.

The vehicle 102 includes an interior to accommodate passengers. The vehicle 102 includes doors, such as a front and rear driver-side and passenger-side doors, to access the interior. The interior includes a driver's seat, front passenger seat, and rear passenger seat or seats (not shown). The interior includes a dashboard. The dashboard may include indicators, such a speedometer and tachometer, air vents, the display 112 (e.g., an entertainment or infotainment system screen), and vehicle controls.

The sensors 108 generate different types of data that may be stored in the storage 120 of the control system 106. In some embodiments, the sensors 108 sense characteristics of an environment surrounding the vehicle 102 or information about the environment. In some embodiments, the sensors 108 sense characteristics of the vehicle 102 or information about the vehicle's status or state. In some implementations, the sensors 108 sense any of a speed, velocity, acceleration, position, angle, orientation, displacement, vibration, temperature, or weight of the vehicle or vehicle part, component, or subsystem. In some implementations, the sensors 108 sense a gear position (e.g., park, reverse, drive) or emergency/parking brake status (e.g., engaged or disengaged). In some embodiments, the control circuitry 114 adjusts a vehicle parameter associated with characteristics to adjust the vehicle performance or the vehicle's status or state.

In some embodiments, the sensors 108 sense characteristics about a suspension of the vehicle 102. In some implementations, the suspension characteristics include any of firmness or height. In some embodiments, the control circuitry 114 adjusts a vehicle parameter associated with the suspension characteristics (e.g., via one or more of actuators 116). In some implementations, the suspension vehicle parameter includes any of spring stiffness, damping coefficients, tire stiffness, or ride height (e.g., height off the ground or a center of gravity height).

In some embodiments, the sensors 108 sense characteristics about a translational system of the vehicle 102. In some implementations, the translational characteristics include any of the accelerator and/or brake pedal position, steering wheel position, wheel position, wheel rotation direction, wheel torque, propulsion system output (e.g., engine torque), or estimated range of the vehicle. In some embodiments, the control circuitry 114 adjusts a vehicle parameter associated with the translational characteristics. In some implementations, the translational vehicle parameter includes any of steering, braking, or acceleration sensitivity or responsiveness. In some implementations, the translational vehicle parameter includes any of a threshold or limits for the steering, braking, or acceleration. In some implementations, the translational vehicle parameter includes any of a threshold or limits for the vehicle range or a vehicle state of charge. In some implementations, the translational vehicle parameter includes a gear position or emergency/parking brake status.

In some embodiments, the sensors 108 sense characteristics about an electrical system of the vehicle 102. In some implementations, the electrical characteristics include any of current, voltage, resistance, or temperature. In some implementations, the electrical system of the vehicle 102 includes the propulsion system. In some examples, the electrical characteristics include current state of charge, battery capacity, or charging rates of a battery. In some embodiments, the control circuitry 114 adjusts a vehicle parameter associated with the electrical characteristics. In some implementations, the electrical vehicle parameter includes any of current, voltage, or resistance. In some implementations, the electrical vehicle parameter includes any of a threshold or limits for the voltage or current. In some implementations, the electrical vehicle parameter includes any of a threshold or limits for the charging rates.

In some embodiments, the sensors 108 can sense characteristics about an environment surrounding the vehicle 102. In some implementations, the environmental characteristics include any of temperature, wind speed, humidity, air quality, or proximity or position of nearby objects. In some embodiments, the control circuitry 114 adjusts a vehicle parameter associated with the environmental characteristics. In some implementations, the environmental vehicle parameter includes any of a threshold or limits for a vehicle temperature (e.g., of a vehicle system or vehicle interior), vehicle speed, vehicle acceleration, or proximity to nearby objects. In some implementations, the environmental vehicle parameter includes a profile or exterior dimensions of the vehicle 102.

Each accessory may have a different effect on the vehicle performance. For example, the first accessory may impact airflow into the vehicle 102 (e.g., through an engine bay), which may affect efficiency of a cooling system of the vehicle. The second accessory may affect aerodynamic resistance (e.g., drag) of the vehicle 102, which may impact the vehicle range. The third accessory may affect a vehicle profile or exterior dimensions, which may impact overhead clearance of the vehicle 102 (e.g., when entering a garage). The fourth accessory may affect power usage of the vehicle 102, which may impact the vehicle range or available power for other accessories or vehicle systems. The fifth accessory may affect weight distribution, which may impact how the vehicle 102 handles.

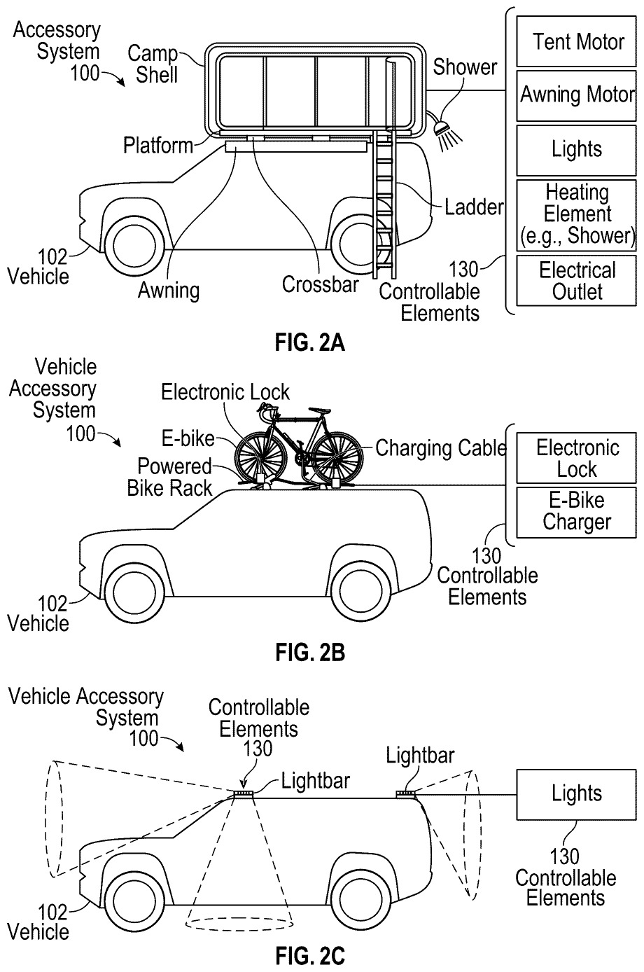

In some embodiments, the control circuitry 114 uses the sensors to detect whether an accessory is attached and/or aspects or properties of the accessory. In some implementations, a proximity sensor or camera is used to detect the presence of an accessory. In some embodiments, the control circuitry 114 accesses a database 122 of vehicle 102 and accessory characteristics (e.g., via communication circuitry 118) to detect whether an accessory is attached. In some embodiments, the database 122 includes entries for different accessory types. In some implementations, the entries indicate any of conditions (e.g., sensor values) for the identifying accessory type, aspects or properties on the accessory type, and controllable elements for the accessory type. In some implementations, the control circuitry 114 compares sensor data to data in the database 122 to identify the presence of the accessory. In some implementations, the control circuitry 114 accesses the database 122 to determine aspects or properties of the accessory. In some examples, the aspects include dimensions, weight, and other properties of the accessory. In some examples, the aspects include the presence of controllable elements that can be controlled by the control circuitry, such as described below, in relation to FIGS. 2A-2C.

In some embodiments, the vehicle ports include weight sensors in order to allow the control circuitry 114 to differentiate between an accessory only and the accessory loaded with gear (e.g., a bike rack loaded with a bike or a roof box loaded with gear).

The control circuitry 114 updates the vehicle accessory system 100 to account for the accessory. In some embodiments, the control circuitry 114 generates, for display on the user interface, a visual of the accessory on the vehicle. The control circuitry 114 may also update a vehicle parameter to account for the accessory.

In some embodiments, the control circuitry 114 adjusts a vehicle parameter based at least in part on the accessory. In some embodiments, the control circuitry 114 changes an environmental vehicle parameter by adjusting a limit for a proximity sensor or by disabling the proximity sensor to allow the accessory to be positioned over the proximity sensor without presenting warnings. In some embodiments, the control circuitry 114 changes an environmental vehicle parameter by adjusting a profile or exterior dimensions of the vehicle while the accessory is coupled to the vehicle 102.

In some embodiments, the control circuitry 114 changes a suspension vehicle parameter by adjusting any of a damping coefficient or ride height of the suspension system to account for the weight of the accessory and the drag imparted by the accessory.

In some embodiments, the control circuitry 114 changes a translational vehicle parameter by adjusting a limit for acceleration (e.g., and deceleration) and setting maximum speed to account for the weight of the accessory and the drag imparted by the accessory. In some embodiments, the control circuitry 114 changes a translational vehicle parameter by setting or confirming a gear position (e.g., change to or stay in park) or an emergency/parking brake status (e.g., engage) to allow use of the accessory (e.g., a camper shell). In some embodiments, the control circuitry 114 changes a translational vehicle parameter by adjusting the vehicle range to account for the reduction on range imparted by the accessory.

In some embodiments, the sensors 108 include any of a current sensor, voltage sensor, temperature sensor, an odometer, an encoder, a global positioning system (GPS) receiver, position sensor, current sensor, voltage sensor, temperature sensor, proximity sensor (e.g., radar sensor, laser radar sensor, ultrasonic sensor, lidar sensor, infrared sensor, light sensor, Hall sensor), pressure sensor, pressure sensor, load sensor, accelerometer, gyrometer (or gyro sensor), inertial measurement unit, tags and readers (e.g., radio frequency identification (RFID), NFC beacon, or Bluetooth beacon) or a camera.

In some embodiments, an accessory (e.g., first accessory 104a) includes a one or more controllable elements 130 that is controlled by the vehicle accessory system 100. In some embodiments, the control circuitry 114 identifies the type of the accessory and to determine the accessory includes the controllable element. In some embodiments, the control circuitry 114 identifies the accessory using the sensors 108. In one example, a camera and load sensor are used to identify the third accessory by visual presence and increase in vehicle weight. In some embodiments, the control circuitry 114 may use the sensor data to query the database 122 and identify a database entry comprising the type of the accessory. In some implementations, the database entry indicates the accessory includes the controllable element, or is linked to another database entries that indicates the accessory includes the controllable element. In some embodiments, the control circuitry 114 identifies the accessory by interfacing with communication circuitry of the accessory (e.g., communication circuitry 132).

In some embodiments, the control circuitry 114 updates the vehicle accessory system 100 to account for the controllable aspects of the accessory. In some embodiments, the control circuitry 114 generates, for display on the user interface, user interface elements for receiving input to control the accessory. The control circuitry 114 receives inputs to control the accessory through interaction with the user interface elements. The control circuitry 114 controls the aspect of the accessory based at least in part on the interaction.

In some embodiments, the control circuitry 114 uses a vehicle parameter, setting, or state to adjust certain accessory settings or control a controllable element. In some implementations, the control circuitry 114 turns on or off a light of the accessory based on whether the vehicle 102 is in a day or night mode (e.g., the light is illuminated in night mode and tuned off in day mode, or a color temperature of the light is adjusted, e.g., to reduce blue light in night mode). In some implementations, the control circuitry 114 uses ambient temperature readings to activate a rooftop tent cooling system of a camper tent accessory. In some embodiments, the control circuitry 114 sends a vehicle parameter, setting, or state to the accessory. In some implementations, the control circuitry 114 sends the temperature readings to circuitry (e.g., control circuitry) of the accessory.

In some embodiments, the control circuitry 114 disables certain vehicle functionality based on the accessory connected or provides a warning through the display. In some implementations, the control circuitry 114 disables the drive gear position (e.g., prevents the vehicle 102 from exiting the park gear position) when a camper tent accessory is fully deployed. In some embodiments, the control circuitry 114 disables a vehicle trunk from opening if bikes or a bike rack are mounted to the vehicle. The control circuitry 114 may also display an alert when low overhead clearance is nearby. In some implementations, the control circuitry 114 disables lighting of an external lighting accessory from being used in when the vehicle is not off-road or in an off-road mode.

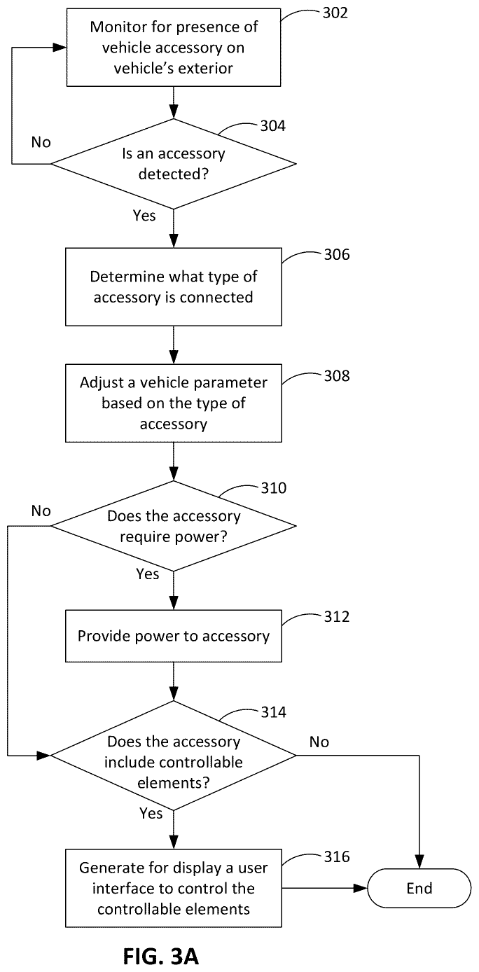

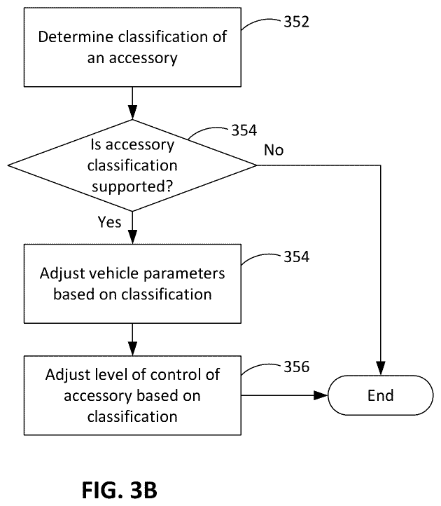

In some embodiments, the vehicle accessory system 100 enables different features based on a classification or tier of the accessory, such as discussed below in relation to FIGS. 2A-3B. In some implementations, based at least in part on the classification, the control circuitry 114 (i) disables control of controllable elements, (ii) enables control of all controllable elements, or (iii) enables control of a subset of controllable elements. In some implementations, based at least in part on the classification, the control circuitry 114 (i) does not consider the effect of the accessory on the vehicle parameters, (ii) adjusts all relevant vehicle parameters as needed, or (iii) enables adjustment of a subset of vehicle parameters. In some embodiments, the classification of the accessory is determined using the database 122. In some implementations, the classification is determined based at least in part on (i) whether the control circuitry 114 identifies a database entry comprising the type of the accessory and/or (ii) an indication of the classification in identified database entry. In some embodiments, accessories of a common type can have different classifications. For example, an original equipment manufacturer (OEM) tent may be classified as a first tier accessory that is fully controllable, a licensed or partner tent may be classified as a second tier accessory that is partially controllable, and a third-party tent may be classified as a third tier accessory that is not controllable.

In some embodiments, the control circuitry 114 updates the vehicle accessory system 100 to account for inputs received from an accessory. For example, the accessory may provide power to the vehicle 102. In some embodiments, the accessory is a solar panel or a generator. In some embodiments, the control circuitry 114 reverses the power direction back into the vehicle 102 to offset the power use of the vehicle or other accessories.

FIGS. 2A-2C are schematic illustrations of vehicle accessory systems 100 having different types of accessories coupled to a roof of a vehicle 102, in accordance with embodiments of the disclosure. In particular, FIGS. 2A-2C show different controllable elements 130 for each type of accessory.

FIG. 2A shows a camper shell accessory and an awning accessory coupled to the vehicle 102. The camper shell includes controllable elements 130, such as a tent motor to open and stow the camper shell, lights to illuminate the interior of the camper shell, and an electrical outlet (e.g., NEMA 1-15 or American standard NEMA 5-15) to plug devices into and provide power to the devices. The camper shell is coupled to a roof of the vehicle 102 (e.g., using crossbars and/or a platform). A ladder extends from the camper shell to the ground to allow a user to access an inside of the camper shell. In some embodiments, the controllable elements 130 include a motor to raise and lower the ladder.

In the depicted embodiment, the camper shell comprises a shower. The shower includes a shower head and water input or reservoir. The shower includes the controllable element of a heating element to warm the water and allow for a warm shower. In some embodiments, the shower is coupled to at least one of a water reservoir or a pressurized water supply. In some embodiments, the shower includes a pump to move water through the shower head. In some embodiments, the shower, or part of the shower, is attached to the vehicle or the ladder. In some embodiments, the camper shell includes an air mattress and a controllable element of an air pump and/or vacuum to inflate and/or deflate the air mattress. In some embodiments, the controllable elements 130 include any of a fan motor, ventilation system, or heating and/or cooling system to control the temperature inside the camper shell, such as discussed in relation to FIG. 4.

In the embodiment depicted in FIG. 2A, the awning is attached to the crossbars. In some embodiments, the awning is attached to any of the platform, camper tent, or an anchor point of the vehicle. The awning includes the controllable element of an awning motor to extend and retract the awning.

In some embodiments, the camper shell, shower, and awning may be of a classification. As an example, the classifications may include a first tier (e.g., an original equipment manufacturer (OEM) accessory), a second tier (e.g., a licensed or partner accessory), or a third tier (e.g., a third-party accessory). As previously discussed in relation to FIG. 1, a level of control of the controllable elements and adjustment of the vehicle parameters may depend on the classification. As an illustrative example, if the previously discussed camper shell is considered a first-tier accessory, which is fully controllable, then the control circuitry may be configured to provide power to and control all of the controllable elements of the camper shell. However, if the camper shell is considered a second tier accessory, then the control circuitry may be configured to only provide power to and control a light controllable element, and if the camper shell is considered a third tier accessory, then the control circuitry may not provide power to or control any of the controllable elements of the camper shell. In some embodiments, the control circuitry (e.g., control circuitry 114) prompts the user for information about a first-tier accessory. For example, the control circuitry may generate for display (e.g., on display 112) a request stating, “we can tell something is plugged into your roof power, please tell us what kind of product you've installed.” The control circuitry may also generate for display selectable categories to solicit information on the accessory, such as what types of controllable elements the accessory includes. Using the received information, the control circuitry may be configured to provide limited power to or control of the controllable elements. In some embodiments, one or more sensors may assist in determining accessory information. For example, a camera or weight sensor may generate sensor data that can be used by the control circuitry of vehicle 102 to identify the accessory or to narrow down the options presented to the user. In some embodiments, an accessory (e.g., a first tier accessory) may include communication circuitry (e.g., communication circuitry 132) such that vehicle 102 can identify the accessory without user input.

FIG. 2B shows a powered bike rack accessory coupled to the vehicle and an E-bike attached to the powered bike rack. The bike rack includes the controllable elements 130 of an electronic lock and a powered port to receive a charging cable connector for charging the E-bike. In some embodiments, the electronic lock includes a latch such as a cinch mechanism, clamps, lock, or a combination thereof configured to secure the E-bike to the powered bike rack. The powered bike rack is attached to the vehicle roof and a connector of the powered bike rack is coupled to a port on the roof. The control circuitry (e.g., control circuitry 114) controls locking and unlocking of the electronic lock and charging of the E-bike. In some embodiments, the control circuitry blocks requests to unlock the electronic lock when the vehicle is moving and/or when the vehicle is not in the park gear position.

FIG. 2C shows lightbars coupled to the vehicle. In some embodiments, the lightbars are part of a powered crossbar. In some embodiments, the lightbars are standalone accessories and not meant to support or be coupled to other accessories. The lightbars include the controllable elements 130 of lights. In some embodiments, the control circuitry controls any of an intensity, brightness, frequency (e.g., strobe or blinking pattern), color, or direction of light emitted by the lightbar.

FIG. 3A is a flowchart of an illustrative process for controlling interaction between a vehicle (e.g., vehicle 102 in FIGS. 1-2C or 5C) and an accessory (e.g., accessories in FIGS. 1-2C), in accordance with embodiments of the disclosure. The process begins at step 302 with control circuitry (e.g., control circuitry 114 in FIG. 1) monitoring for a presence of a vehicle accessory on a vehicle's exterior (e.g., as discussed in relation to FIG. 1). In some embodiments, the control circuitry monitors sensor signals from sensors 108. In some embodiments, the control circuitry monitors whether communication circuitry such as 118 receives any communications from an accessory. At step 304, the control circuitry determines whether an accessory is detected. For example, the control circuitry may detect the presence of an accessory based on a camera sensor capturing an image of a sensor or based on a weight increase from a weight sensor. If an accessory is not detected, the process returns to step 304 for continued monitoring.

If an accessory is detected, the process continues at step 306 with the control circuitry determining what type of accessory is connected, for example, using any of the techniques described above. The process continues at step 308 with the control circuitry adjusting one or more vehicle parameter based on the type of accessory. In some embodiments, the control circuitry may adjust one or more of a suspension firmness, suspension height, a steering threshold or limit, a braking threshold or limit, an acceleration threshold or limit, a maximum vehicle speed, a vehicle gear position, any other parameter discussed above, or any combination thereof. In an illustrative example, if the accessory type is a tent or camper shell and the vehicle is in park, then the suspension height can be adjusted to level the vehicle.

The process then continues at step 310 with the control circuitry determining whether the accessory utilizes or requires power, as discussed in relation to FIG. 1. In some embodiments, this is determined based on the type of accessory, information in database 122, information received from the accessory, or a combination thereof. In some embodiments, if an accessory was not detected the process also continues with control circuitry determining whether the accessory utilizes or requires power. If the accessory device requires power, the process continues at step 312 with control circuitry providing power to accessor (e.g., activating a switch to provide power to an outlet or powered port).

The process then continues at step 314 with the control circuitry determining whether the accessory includes controllable elements (e.g., controllable elements in FIGS. 1-2C), as discussed in relation to FIG. 1. Additionally, if the accessory device does not utilize or require power, the process also continues at 314 with the control circuitry determining whether the accessory includes controllable elements, as discussed above. In some embodiments, this is determined based on the type of accessory, information in database 122, information received from the accessory, or a combination thereof. If the accessory includes controllable elements, the process continues at 316 with the control circuitry generating for display a user interface (e.g., camp shell user interface, discussed below in relation to FIG. 4) to control the controllable elements, as discussed in relation to FIGS. 1-2C and below, in relation to FIG. 4, and then the process concludes. If the accessory does not include controllable elements, or if the user turns off the user interface, the process also concludes.

In some embodiments, if the accessory device does not utilize or require power and the accessory does not include controllable elements, the process continues with control circuitry generating for display a user interface, or updates to a user interface, to display updated items such as range should the accessory impact vehicle function or performance, as discussed in relation to FIG. 1, and then concludes.

FIG. 3B is a flowchart of an illustrative process for controlling interaction between a vehicle (e.g., vehicle 102 in FIGS. 1-2C or 5C) and an accessory (e.g., accessories in FIGS. 1-2C) based on a classification of the accessory, in accordance with embodiments of the disclosure. The process begins at 352 with control circuitry (e.g., control circuitry 114 in FIG. 1) determining a classification of an accessory (e.g., as discussed in relation to FIG. 1). In some embodiments, the classification may have two or more tiers (e.g., three tiers). In an illustrative example, an OEM accessory may be classified as a first tier accessory, a licensed or partner accessory may be classified as a second tier accessory, and a third party accessory may be classified as a third tier accessory. The process then continues at 354 with the control circuitry determining whether the accessory classification supported, as discussed in relation to FIG. 1.

For example, a first tier accessory may be fully supported, a second tier accessory may be partially supported, and a third tier accessory may not be supported. If the accessory classification is supported (e.g., at least partially), the process continues at 354 with the control circuitry adjusting vehicle parameters based on the accessory classification, as discussed in relation to FIG. 1. The process continues at 356 with the control circuitry adjusting a level of control (e.g., full control or partial control) of the accessory based on the accessory classification, as discussed in relation to FIGS. 1 and 2A and then concludes. If the accessory classification is not supported, the process concludes.

It will be understood that although the steps of FIGS. 3A-B are described in a particular order, the order is merely illustrative and not limiting. In some embodiments, one or more steps may be omitted, repeated, or performed in a different sequence. Additionally, it will be understood that the process of FIG. 3B can be incorporated into FIG. 3A to influence, for example, what vehicle parameters are adjusted at 308 and what user interface elements are generated for display at 316.

FIG. 4 is a representation of a graphical user interface (GUI) 400 of a vehicle accessory system, in accordance with embodiments of the disclosure. In particular, GUI 400 shows a camp shell user interface. The GUI 400 is shown displayed on a display (e.g., display 112) of the vehicle (e.g., vehicle 102). In some embodiments, the GUI 400, or elements of the GUI 400 are displayed on a display of a user device. The GUI 400 includes several user interface elements, including a camp shell UI element 402 (e.g., visual representation), camp shell temperature UI element 404, electrical outlet UI element 406, and light UI element 408. Interacting with the user interface elements for any of the camp shell temperature, electrical outlet, and lights causes the control circuitry to control corresponding controllable elements of the camp shell. For example, the camp shell temperature UI element 404 may be used to control a fan to adjust temperature inside the camp shell. In some embodiments, the camp shell temperature UI element 404 is used to control an of a heating element, ventilation system, or heating and/or cooling system. The electrical outlet UI element 406 may be used to turn power on and off to an electrical outlet in the camp shell. In some embodiments, the electrical outlet UI element 406 is used to adjust voltage and/or current of the electrical outlet. In some embodiments, the electrical outlet includes a USB port for charging user devices. The light UI element 408 may be used to control lights (e.g., interior and/or exterior) of the camp shell. In some embodiments, the GUI 400 includes a status information UI element 410 to provide general information, such as time, an ambient or outdoor temperature, or a network connectivity strength of the vehicle accessory system.

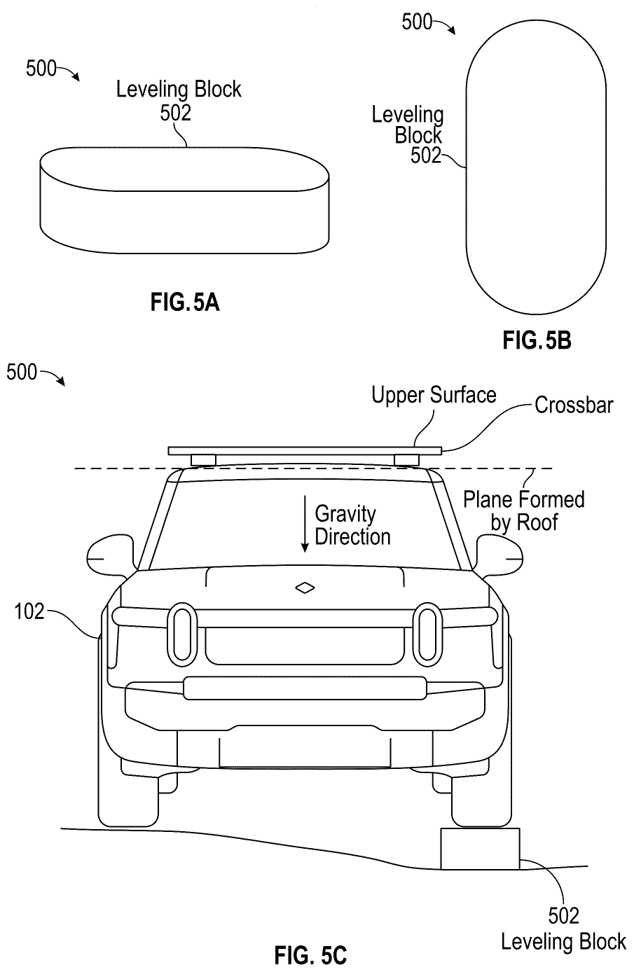

FIGS. 5A-5C are schematic illustrations of a vehicle leveling system 500, in accordance with embodiments of the disclosure. The vehicle leveling system 500 includes one or more leveling blocks 502. FIG. 5A shows a side perspective view of a leveling block 502 and FIG. 5B shows a top view of the leveling block 502. As depicted in FIGS. 5A and 5B, the leveling block 502 generally has a pill shape. In some embodiments, the leveling block 502 may be shaped like any of a rectangle, circle, or oval, to name a few examples. The leveling block 502 is made of a material that can support the weight of the vehicle 102 transferred through at least one tire. In some embodiments, the leveling block 502 comprises a non-slick material or coating.

FIG. 5C shows the vehicle 102 parked on uneven terrain. The leveling block 502 is shown under a driver's side front wheel, such as between (and directly contacting) a tire on one side and the ground on an opposite side. In some embodiments, a driver's side rear wheel is also supported by a leveling block. The leveling block 502 is used to level the vehicle 102. In some embodiments, the vehicle 102 is level when a plane formed by a roof of the vehicle 102 is orthogonal or perpendicular to a direction of gravity. In some embodiments, the vehicle 102 is level when a plane formed by an upper surface of a cross bar (or platform attached to the crossbar) is orthogonal or perpendicular to a direction of gravity. In some embodiments, the control circuitry (e.g., control circuitry 114) determines the vehicle 102 is level when data from a sensor (e.g., an accelerometer sensor) indicates a roll or pitch angle of the vehicle 102 is within a level threshold. In some embodiments, the level threshold is 5 to −5 degrees, 3 to −3 degrees, 2 to −2 degrees, 1 to −1 degrees, 0.5 to −0.5 degrees, or any other suitable threshold range. In some embodiments, the control circuitry uses data from a sensor of the accessory to determine if the vehicle 102 is level (or if the accessory is level). In some implementations, sensors to measure pitch and roll of the vehicle 102 are used.

In some embodiments, the control circuitry communicates with circuitry of the leveling block to determine the position of the leveling block in relation to the wheels.

In some embodiments, the control circuitry uses data from sensors on the vehicle 102 to determine if any leveling blocks are needed, or how many leveling blocks, or what type of leveling blocks to use. In some embodiments, the control circuitry uses the sensor data to determine the plane and whether the plane is within the level threshold of perpendicularity with the direction of gravity. In some embodiments, the control circuitry uses data collected while the vehicle 102 is stopped or in park. In some embodiments, the control circuitry uses data collected while the vehicle 102 is moving, such that the data characterizes terrain that has been traversed by wheels of the vehicle 102.

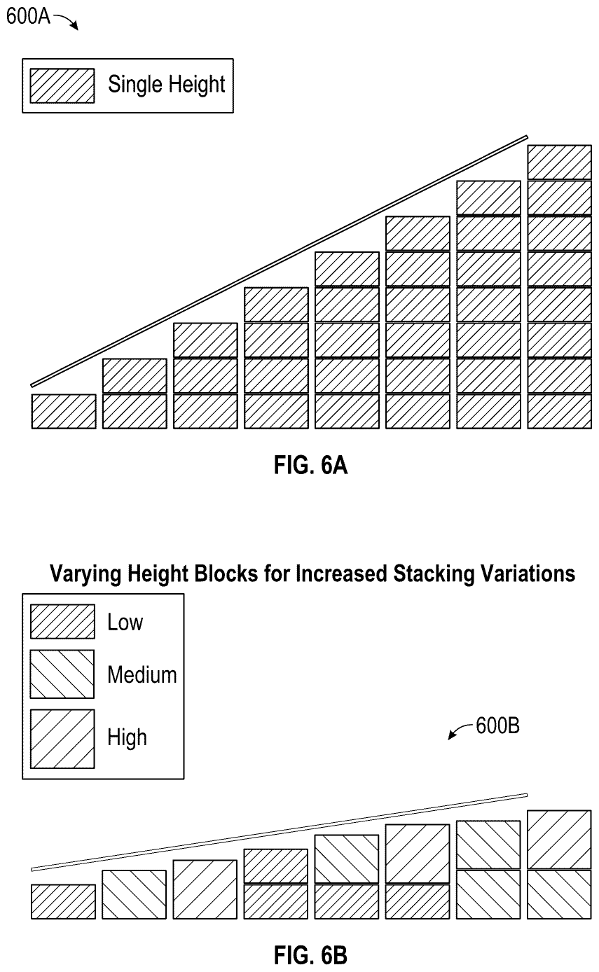

FIGS. 6A and 6B are schematic illustrations of different stacking configurations 600A and 600B for leveling blocks of a vehicle leveling system, in accordance with embodiments of the disclosure.

FIG. 6A shows an angle created by using leveling blocks of a single height for stacking configuration 600A. For example, going from left to right, eight pillars are formed using one leveling block, then two leveling blocks, then three leveling blocks, up to eight leveling blocks.

FIG. 6B shows an angle created by using different types of leveling blocks for stacking configuration 600B. In particular, leveling blocks of three different heights (e.g., low, medium, and high) are shown. For example, going from left to right, eight pillars are formed using two low leveling blocks, one low leveling block and one medium leveling block, one low leveling block and one high leveling block, two medium leveling blocks, and one medium leveling block and one high leveling block.

The angle in FIG. 6B is less than the angle in FIG. 6A since different types of leveling blocks are used.

FIGS. 7A-7C are representations of different GUIs of a vehicle leveling system, in accordance with embodiments of the disclosure. In some embodiments, the GUIs are displayed on a display of the vehicle. In some embodiments, the GUIs or elements of the GUIs are displayed on a display of a user device.

FIG. 7A shows a GUI 700 displaying an instruction 702 to use one medium leveling block 704 stacked on one low leveling block 706, and to place the leveling block stack under the front driver's side wheel. In the embodiment depicted, the GUI 700 includes a visual showing the leveling blocks under a wheel and a line identifying the wheel of the vehicle under which to place the leveling blocks. The GUI 700 also includes text instruction 702 stating “place two blocks under front left tire.”

In some embodiments, the GUI 700 indicates whether to put a leveling block in front or behind the wheel before moving the vehicle on top of the leveling block. In some implementations, whether to put a leveling block in front or behind the wheel is determined based on the direction of travel before the vehicle comes to a stop (or enters the park gear position). In some examples, the vehicle stores sensor data (e.g., in storage 120 in FIG. 1) and knows the terrain/elevation of the ground on the path traveled by the vehicle. In some examples, the terrain/elevation is known using sensor data captured while the vehicle is moving. In some examples, the control circuitry accesses terrain/elevation data from storage of a database (e.g., vehicle and accessory database 122 in FIG. 1). Therefore, if the vehicle was driven forward before coming to a stop, the vehicle may tell the user to place the blocks behind the wheel and instruct the user to back up onto the blocks.

In some embodiments, the control circuitry autonomously drives the vehicle on to the leveling blocks. In some implementations, the autonomous driving is enabled based on an input (e.g., enabling autonomous driving through the GUI). In some embodiments, the control circuitry generates for display, feedback and/or guidance to position the wheel on the control blocks as the vehicle is moving towards the leveling blocks. In some implementations, the feedback and/or guidance includes visual feedback (e.g., shown on the display). In some embodiments, the feedback and/or guidance includes auditory feedback (e.g., played through a speaker of the vehicle or a connected device).

FIG. 7B shows a sequence of two GUI screens. A first GUI 710A screen is similar to the GUI 700 discussed in relation to FIG. 7A. The second GUI 710B displays an additional instruction to place a low leveling block 704 under the rear driver's side wheel. Thus, the GUI screens depicted in FIG. 7B show instructions to raise the driver's side of the vehicle to level the vehicle.

FIG. 7C shows a GUI 720 displaying an instruction to move to flatter ground. In the depicted embodiment, the control circuitry could not determine a leveling block combination to level the vehicle, or the leveling blocks required would be too unstable. A displayed instruction 722 reads “no leveling block configuration available - move to flatter ground.”

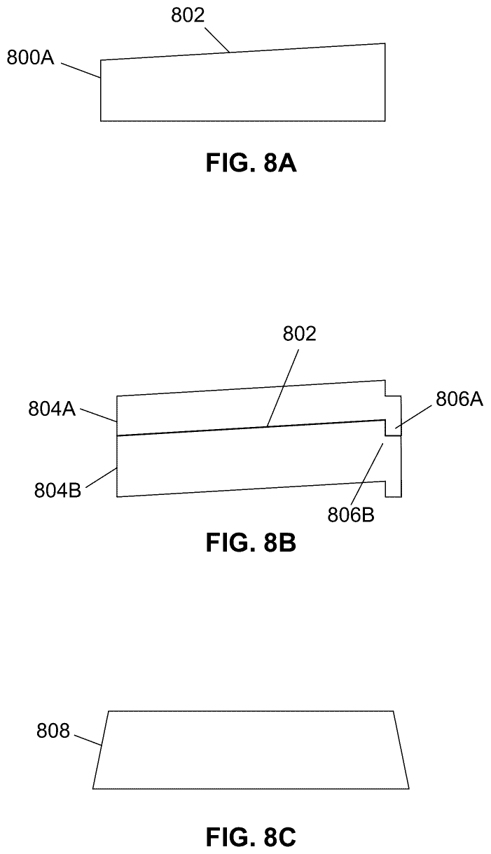

FIGS. 8A-8C are schematic illustrations of different leveling block configurations, in accordance with embodiments of the disclosure.

FIG. 8A shows a sloped leveling block 800 having a sloped upper surface 802. In some embodiments, the sloped upper surface 802 provides a continuous slope between adjacent sloped leveling blocks (e.g., leveling blocks of adjacent pillars), or a smooth transition between the sloped leveling blocks.

FIG. 8B shows sloped interlocking leveling blocks 804A and 804B. A sloped interlocking small leveling block 804A rests on top of a sloped interlocking medium leveling block 804B. A sloped upper surface 802 of the sloped interlocking medium leveling block 804B contacts a sloped lower surface of the sloped interlocking small leveling block 804A. A retention feature 806A (e.g., a tab) of the sloped interlocking small leveling block 804A engages a retention feature 806B (e.g., a notch) of the sloped interlocking medium leveling block 804B. In the depicted embodiment, a tab protruding from the sloped lower surface of the sloped interlocking small leveling block 804A engages a notch in the sloped upper surface of the sloped interlocking medium leveling block 804B. In some embodiments, the retention features 804A and 804B prevent the leveling blocks from sliding or separating, e.g., when a vehicle drives on or off the leveling block stack.

FIG. 8C shows a tapered leveling block 808 having tapered sides. In some embodiments, the tapered sides continuing tapering as tapered leveling blocks are stacked. In some embodiments, the tapered leveling block 808 provides a wider base to support weight of the vehicle.

In some embodiments, any of the leveling blocks discussed in relation to FIGS. 5A-7C may include magnetic features to couple the leveling blocks to one another (e.g., stacked blocks or adjacent blocks).

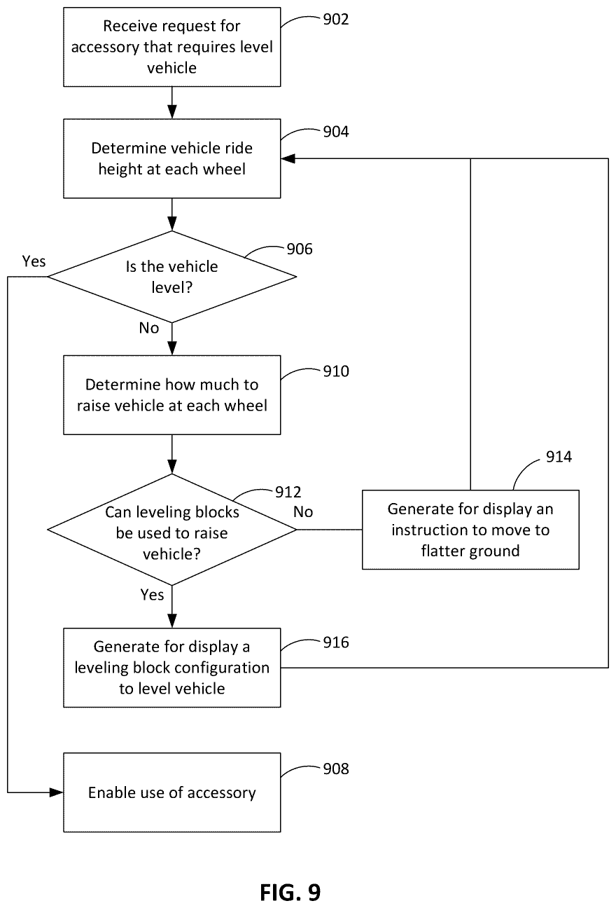

FIG. 9 is a flowchart of an illustrative process for leveling a vehicle (e.g., vehicle 102 in FIGS. 1-2C or 5C) using a vehicle leveling system (e.g., leveling blocks in FIGS. 5A-6B), in accordance with embodiments of the disclosure.

The process begins at step 902 with control circuitry (e.g., control circuitry 114 in FIG. 1) receiving a request for an accessory that prefers or requires a vehicle to be level, as discussed in relation to FIGS. 1 and 2A. In some embodiments, the request is received independent of, or regardless of, whether an accessory is requested. In some implementations, the request is a request to level the vehicle. In some implementations, the request is a request to prepare for sleeping in the vehicle without an accessory. The process continues at step 904 with the control circuitry determining a vehicle ride height at each wheel, as discussed in relation to FIG. 1. For example, the control circuitry may read or access sensor data associated with vehicle ride height. The process continues at step 906 with the control circuitry determining whether the vehicle is level, as discussed in relation to FIG. 5C.

If the vehicle is level, the process proceeds at step 908 and ends with enabling use of the accessory, as discussed in relation to FIGS. 1-3B. In some embodiments, the control circuitry provides power to the accessory. In some embodiments, the control circuitry enables control of controllable elements of the accessory, as discussed in relation to FIG. 1. If the vehicle is not level, the process continues at step 910 with the control circuitry determining how much to raise the vehicle at each wheel, as discussed in relation to FIG. 5C. In some embodiments, a vehicle plane is determined and is used to determine how much to raise the vehicle, as discussed in relation to FIG. 5C. In some embodiments, a wheel at the highest point is determined and the other wheels are raised a distance required to be at the highest point. The process continues at step 912 with the control circuitry determining whether leveling blocks can be used to raise the vehicle, as discussed in relation to FIGS. 5C and 7C. If leveling blocks cannot be used, the process continues at step 914 with the control circuitry generating for display an instruction to move to flatter ground, as discussed in relation to FIG. 7C. In some embodiments, the control circuitry determines the vehicle was moved (e.g., by moving and stopping, by changing to a drive gear position and then to a park gear position). In some embodiments, the control circuitry generates for display a user interface element requesting confirmation that the vehicle was moved. After the vehicle has moved to flatter ground, the process returns to step 904 to determine a vehicle ride height at each wheel, as discussed above. If leveling blocks can be used, the process continues at step 916 with the control circuitry generating for display a leveling block configuration to level the vehicle, as discussed in relation to FIGS. 7A and 7B. Once the leveling blocks are used, the process returns to step 904 to determine a vehicle ride height at each wheel (e.g., to confirm whether the vehicle is now level) and subsequent operations, as discussed above.

It will be understood that although the steps of FIG. 9 are described in a particular order, the order is merely illustrative and not limiting. In some embodiments, one or more steps may be omitted, repeated, or performed in a different sequence.

The following embodiments describe various methods and systems in accordance with this disclosure.

In some embodiments, methods and systems are provided for modifying a vehicle parameter based on an accessory. An accessory is determined to be coupled to an exterior of a vehicle and a type of accessory is identified. A vehicle parameter is modified based on the type of accessory. In some embodiments, modifying the vehicle parameter includes modifying at least one of a predicted vehicle range, vehicle exterior profile, vehicle suspension, motor torque output, brake input, maximum vehicle speed or acceleration, traction control, vehicle height, steering ratio, or vehicle user interface.

In some embodiments, determining the accessory is coupled to the exterior of the vehicle is based on determining a vehicle parameter is outside of an expected performance range. In some embodiments, the expected performance range is one of a vehicle range, distance to surroundings, vehicle weight, engine output, brake input, or vehicle speed or acceleration. In some embodiments, the sensor comprises any of a pressure sensor, load sensor, camera, accelerometer, gyrometer, inertial measurement unit, or current sensor.

In some embodiments, the type of accessory is identified based at least in part on vehicle sensor data. In some embodiments, the sensor data is used to query a database and identify the type of accessory. In some embodiments, the type of accessory is received through an input.

In some embodiments, the accessory is one of a plurality of accessories. Each of the plurality of accessories has a different form factor and different weight. In some embodiments, the plurality of accessories comprise at least one of a rooftop camper shell or tent, bike rack, powered locking mechanism, lighted crossbar, powered crossbar, powered awning, or heated shower.

In some embodiments, the methods and systems further comprise controlling a controllable element of the accessory. The controllable element is determined based on the type of accessory. In some embodiments, the accessory is a powered accessory configured to receive power from the vehicle. In some embodiments, controlling includes providing power to the controllable element. In some embodiments, power is provided to the accessory based on a status of the vehicle.

In some embodiments, the plurality of accessories comprises at least one of a heating element, water pump, air pump, vacuum, actuator, winch, light, compressor, or fan. In some embodiments, the powered accessory is configured to provide power to the vehicle and the vehicle is configured to receive power from the powered accessory. In some embodiments, the powered accessory comprises at least one of a solar panel or a generator.

In some embodiments, methods and systems are provided for determining features to enable based on accessory classification. In some embodiments, a compatibility classification of the accessory device is determined. If the accessory classification is supported, then vehicle parameters are adjusted. A level of control of the accessory is adjusted. If the classification is not supported, then no vehicle parameters and no control of the accessory is enabled. In some embodiments, the modifying a parameter associated with the accessory is based at least in part on the compatibility classification exceeding a classification threshold or level.

In some embodiments, methods and systems are provided for leveling a vehicle. A vehicle orientation (e.g., levelness) is determined. The vehicle orientation is compared to a threshold and if the vehicle orientation is outside of an orientation threshold, a wheel height adjustment amount for at least one wheel of the vehicle to adjust the orientation of the vehicle is determined. A level configuration for raising the vehicle within a height adjustment threshold is determined. A leveling block to use for the height adjustment is determined. A leveling block configuration showing what leveling blocks to use for the at least one wheel is generated for display.

In some embodiments, comparing the vehicle orientation to a threshold comprises determining whether a plane formed by the vehicle is perpendicular to a direction of gravity. In some embodiments, the plane is formed by a vehicle roof. In some embodiments, the plane is formed by a roof rack or roof carriage. In some embodiments, comparing the vehicle orientation to a threshold comprises determining whether a plane formed by the accessory is perpendicular to a direction of gravity.

In some embodiments, determining a leveling block configuration comprises determining a leveling block type from a plurality of leveling block types. Each leveling block type comprises a leveling block having a particular height.

In some embodiments, data from a vehicle sensor is received while the vehicle is moving. The data indicates an orientation of the vehicle. In some embodiments, the vehicle orientation is determined, while the vehicle is stopped or in park, based at least in part on the moving data.

In some embodiments, a system comprises control circuitry configured to perform any of the methods or operations discussed above. In some embodiments, the system comprises communication circuitry to receive inputs and/or send outputs for the system. In some embodiments, the communication circuitry is configured to receive any of sensor data or communication for an accessory. In some embodiments, the communication circuitry is configured to send communication to the accessory.

In some embodiments, a non-transitory computer-readable storage medium comprises computer-executable instructions that, when executed by a processor, cause the processor to perform any of the methods or operations discussed above.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following embodiments.

What is claimed is:

1. A method comprising:
detecting a presence of an accessory coupled to an exterior of a vehicle;
determining, using control circuitry, an accessory type of the detected accessory; and
adjusting, using the control circuitry, a vehicle parameter based on the accessory type.

2. The method of claim 1, further comprising:
determining whether the detected accessory utilizes power; and
in response to determining that the detected accessory utilizes power, providing power to the accessory.

3. The method of claim 1, further comprising:
determining whether the detected accessory comprises controllable elements; and
in response to determining that the detected accessory comprises one or more controllable elements, generating for display a user interface to control the one or more controllable elements.

4. The method of claim 3, wherein:
the detected accessory is a camper shell or tent; and
the one or more controllable elements comprises an interior temperature, an electrical outlet, or a light, or a combination thereof.

5. The method of claim 1, wherein adjusting the vehicle parameter comprises adjusting a suspension firmness or a suspension height.

6. The method of claim 1, wherein adjusting the vehicle parameter comprises adjusting a steering threshold or limit, a steering ratio, braking threshold or limit, or acceleration threshold or limit, or a maximum vehicle speed.

7. The method of claim 1, wherein the presence of the accessory is detected using a sensor.

8. The method of claim 7, wherein the sensor comprises a proximity sensor, a camera, a load sensor, or an accelerometer.

9. The method of claim 1, further comprising:
determining a classification of the accessory, wherein adjusting the vehicle parameter is based on the classification.

10. The method of claim 1, wherein adjusting the vehicle parameter comprises generating for display a user interface comprising instructions placing one or more leveling blocks under one or more wheels to level the vehicle.

11. A system, comprising:
a sensor configured to generate sensor data; and
control circuitry coupled to the sensor and configured to:
detect, based on the sensor data, a presence of an accessory coupled to an exterior of a vehicle;
determine an accessory type of the detected accessory; and
adjust a vehicle parameter based on the accessory type.

12. The system of claim 11, wherein the control circuitry is further configured to:
determine whether the detected accessory utilizes power; and
in response to determining that the detected accessory utilizes power, provide power to the accessory.

13. The system of claim 11, wherein the control circuitry is further configured to:
determine whether the detected accessory comprises controllable elements; and
in response to determining that the detected accessory comprises one or more controllable elements, generate for display a user interface to control the one or more controllable elements.

14. The system of claim 13, wherein:
the detected accessory is a camper shell or tent; and
the one or more controllable elements comprises an interior temperature, an electrical outlet, or a light, or a combination thereof.

15. The system of claim 11, wherein adjusting the vehicle parameter comprises adjusting a suspension firmness or a suspension height.

16. The system of claim 11, wherein the control circuitry is configured to adjust the vehicle parameter by adjusting a steering threshold or limit, a steering ratio, braking threshold or limit, or acceleration threshold or limit, or a maximum vehicle speed.

17. The system of claim 11, wherein the sensor comprises a proximity sensor, a camera, a load sensor, or an accelerometer.

18. The system of claim 11, wherein the control circuitry is further configured to:
determine a classification of the accessory, wherein the control circuitry is configured to adjust the vehicle parameter is based on the classification.

19. The system of claim 11, wherein the control circuitry is configured to adjust the vehicle parameter by generating for display a user interface comprising instructions placing one or more leveling blocks under one or more wheels to level the vehicle.

20. Non-transitory computer-readable storage medium comprises computer-executable instructions that, when executed by control circuitry, cause the control circuitry to:
detect a presence of an accessory coupled to an exterior of a vehicle;
determine an accessory type of the detected accessory; and
adjust a vehicle parameter based on the accessory type.
